(19) United States
(12) Patent Application Publication
(10) Pub. No.: US 2026/0213059 A1
(43) Pub. Date: Jul. 23, 2026

(54) POWDER MAGNETIC CORE, INDUCTOR, AND METHOD FOR MANUFACTURING POWDER MAGNETIC CORE

(71) Applicant: TOKIN Corporation, Miyagi (JP)

(72) Inventors: Akiko OSHIMA, Miyagi (JP); Yosuke IMANO, Miyagi (JP); Satoru MATSUZAWA, Miyagi (JP)

(21) Appl. No.: 19/152,316

(22) PCT Filed: Feb. 2, 2024
(86) PCT No.: PCT/JP2024/003503

§ 371 Date: Jul. 30, 2025

(30) Foreign Application Priority Data
Feb. 13, 2023 (JP) 2023-020052

(51) Int. Cl. H01F 17/04; H01F 41/02

(52) U.S. Cl. CPC H01F 17/04; H01F 41/0246; H01F 2017/048

(57) ABSTRACT

A powder magnetic core capable of improving the reliability of an inductor is provided. A powder magnetic core according to one aspect of the present disclosure is a powder magnetic core in which a magnetic powder is bonded via an insulating layer. The insulating layer includes a phosphoric acid-based insulating material, a resin material, and a moisture absorption inhibitor containing calcium. For example, a weight ratio (Ca/P) of calcium contained in the moisture absorption inhibitor to phosphorus contained in the phosphoric acid-based insulating material is 0.10 or greater.

### CROSS REFERENCE TO RELATED APPLICATIONS

The present application is a U.S. National Phase of International Application No. PCT/JP2024/003503 entitled “DUST CORE, INDUCTOR, AND DUST CORE MANUFACTURING METHOD”, and filed on Feb. 2, 2024. International Application No. PCT/JP2024/003503 claims priority to Japanese Patent Application No. 2023-020052 filed on Feb. 13, 2023. The entire contents of each of the above-listed applications are hereby incorporated by reference for all purposes.

### TECHNICAL FIELD

The present disclosure relates to a powder magnetic core, an inductor, and a method for manufacturing a powder magnetic core.

### BACKGROUND ART

In recent years, inductors have been used in a variety of electronic devices. Therefore, it is important to improve the reliability of inductors in order to improve the reliability of electronic devices. Patent Literature 1 discloses a method for manufacturing a pressed powder body of an amorphous magnetically soft alloy that is less diminished in magnetic permeability in a high frequency range.

### CITATION LIST

### Patent Literature

Patent Literature 1: Japanese Unexamined Patent Application Publication No. H10-212503

### SUMMARY OF INVENTION

### Technical Problem

As described above, inductors are used in a variety of electronic devices. Such electronic devices are expected to be used in various environments. Therefore, in order to improve the reliability of electronic devices, it is important to use inductors the characteristics of which do not deteriorate even when they are used in various environments, that is, highly reliable inductors.

In view of the aforementioned problem, an object of the present disclosure is to provide a powder magnetic core, an inductor, and a method for manufacturing a powder magnetic core that are capable of improving the reliability of an inductor.

### Solution to Problem

A powder magnetic core according to one aspect of the present disclosure is a powder magnetic core in which a magnetic powder is bonded via an insulating layer. In the powder magnetic core, the insulating layer includes a phosphoric acid-based insulating material, a resin material, and a moisture absorption inhibitor containing calcium.

An inductor according to one aspect of the present disclosure is an inductor including the above-described powder magnetic core and a coil.

A method for manufacturing a powder magnetic core according to one aspect of the present disclosure includes: a process of coating a surface of a magnetic powder with a phosphoric acid-based insulating material; a process of coating the magnetic powder coated with the phosphoric acid-based insulating material with a moisture absorption inhibitor containing calcium; a process of adding a resin material to the magnetic powder coated with the moisture absorption inhibitor and granulating the magnetic powder to which the resin material has been added; and a process of molding and thermally curing the granulated magnetic powder.

A method for manufacturing a powder magnetic core according to another aspect of the present disclosure includes: a process of coating a surface of a magnetic powder with a phosphoric acid-based insulating material; a process of adding a moisture absorption inhibitor containing calcium and a resin material to the magnetic powder coated with the phosphoric acid-based insulating material and granulating the magnetic powder to which the moisture absorption inhibitor and the resin material have been added; and a process of molding and thermally curing the granulated magnetic powder.

### Advantageous Effects of Invention

According to the present disclosure, it is possible to provide a powder magnetic core, an inductor, and a method for manufacturing a powder magnetic core that are capable of improving the reliability of an inductor.

### BRIEF DESCRIPTION OF DRAWINGS

FIG. 1 is a schematic diagram for explaining a first aspect of a powder magnetic core according to an embodiment;

FIG. 2 is a schematic diagram for explaining a second aspect of the powder magnetic core according to the embodiment;

FIG. 3 is a flowchart for explaining a method for manufacturing the powder magnetic core according to the first aspect;

FIG. 4 is a flowchart for explaining a method for manufacturing the powder magnetic core according to the second aspect;

FIG. 5 is a graph showing a relationship between Ca/P and a weight increase rate when a magnetic powder was coated with calcium carbonate; and

FIG. 6 is a graph showing a relationship between Ca/P and a weight increase rate when calcium carbonate was added to a magnetic powder.

### DESCRIPTION OF EMBODIMENTS

An embodiment will be described below.

A powder magnetic core according to this embodiment is a powder magnetic core in which a magnetic powder is bonded via an insulating layer. The insulating layer includes a phosphoric acid-based insulating material, a resin material, and a moisture absorption inhibitor containing calcium. With the above structure, the powder magnetic core according to this embodiment can realize a powder magnetic core capable of improving the reliability of an inductor. Further, an inductor according to this embodiment may be formed using the above-described powder magnetic core and a coil. The powder magnetic core according to this embodiment will be described in detail below.

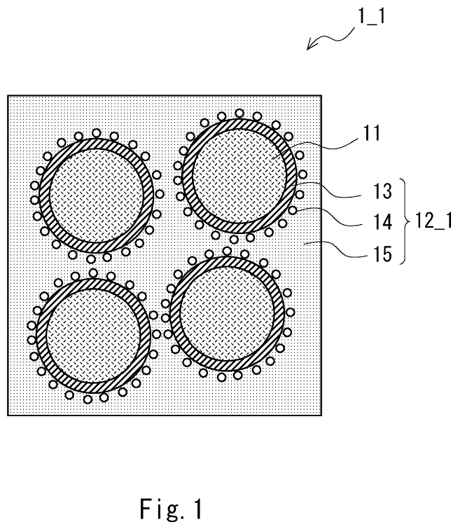

FIG. 1 is a schematic diagram for explaining a first aspect of the powder magnetic core according to this embodiment, and is an enlarged schematic diagram of a part of the powder magnetic core. As shown in FIG. 1, a powder magnetic core 1_1 according to the first aspect is a powder magnetic core in which a magnetic powder 11 is bonded via an insulating layer 12_1. The insulating layer 12_1 includes a phosphoric acid-based insulating material 13, a resin material 15, and a moisture absorption inhibitor 14 containing calcium.

In the powder magnetic core 1_1 according to the first aspect, a surface of the magnetic powder 11 is coated with the phosphoric acid-based insulating material 13, and the surface thereof is further coated with the moisture absorption inhibitor 14. Further, the magnetic powder 11 coated with the phosphoric acid-based insulating material 13 and the moisture absorption inhibitor 14 is bonded using the resin material 15. Note that, in the powder magnetic core 1_1 according to the first aspect, the surface of the magnetic powder 11 may be coated with the moisture absorption inhibitor 14, and the resin material 15 may contain the moisture absorption inhibitor 14.

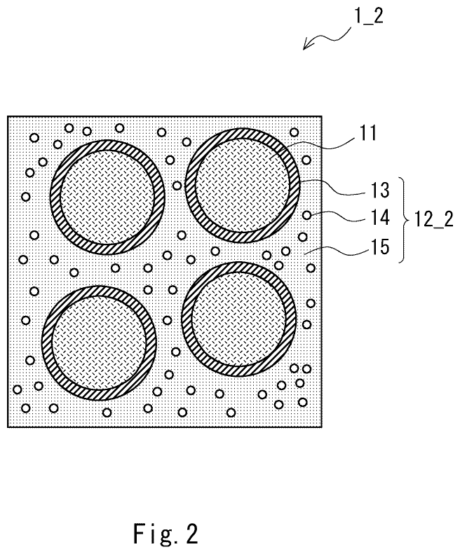

FIG. 2 is a schematic diagram for explaining a second aspect of the powder magnetic core according to this embodiment, and is an enlarged schematic diagram of a part of the powder magnetic core. As shown in FIG. 2, a powder magnetic core 1_2 according to the second aspect is a powder magnetic core in which the magnetic powder 11 is bonded via an insulating layer 12_2. The insulating layer 12_2 includes the phosphoric acid-based insulating material 13, the resin material 15, and the moisture absorption inhibitor 14 containing calcium.

In the powder magnetic core 1_2 according to the second aspect, a surface of the magnetic powder 11 is coated with the phosphoric acid-based insulating material 13. Further, the magnetic powder 11 coated with the phosphoric acid-based insulating material 13 is bonded using the resin material 15 containing the moisture absorption inhibitor 14. In other words, in the powder magnetic core 1_2 according to the second aspect, the moisture absorption inhibitor 14 is dispersed in the resin material 15.

In the powder magnetic core 1_1 according to the first aspect and the powder magnetic core 1_2 according to the second aspect, the moisture absorption inhibitor 14 is included in the insulating layers 12_1 and 12_2. Therefore, the powder magnetic cores 1_1 and 1_2 can be prevented from absorbing moisture. Specifically, the calcium contained in the moisture absorption inhibitor 14 suppresses the moisture absorption tendency of phosphorus present in the powder magnetic cores 1_1 and 1_2, thereby preventing the cores from absorbing moisture from the atmosphere. Therefore, the reliability of the inductor can be improved. Note that, in the following description, the powder magnetic core 1_1 according to the first aspect and the powder magnetic core 1_2 according to the second aspect will be collectively referred to as a powder magnetic core 1 according to this embodiment. Further, the insulating layer 12_1 and the insulating layer 12_2 will be collectively referred to as an insulating layer 12.

A soft magnetic powder can be suitably selected from materials exhibiting soft magnetic properties. In terms of magnetic properties, a material containing iron is preferably used, and iron or an alloy containing iron and other elements may be used. The soft magnetic powder preferably contains an iron alloy powder such as carbonyl iron, an Fe—Si alloy, an Fe—Ni alloy, an Fe—Si—Cr alloy, an Fe—Si—Al alloy, an Fe-based amorphous alloy powder containing at least Fe—B, and an Fe-based nanocrystalline alloy containing at least Fe—B—P—Cu. Note that the Fe-based amorphous alloy refers to an amorphous alloy having no crystalline structure among Fe-based alloys. Further, the Fe-based nanocrystalline alloy refers to an alloy obtained by performing heat treatment on the Fe-based amorphous alloy and precipitating fine α-Fe crystals in the amorphous phase. Only one type of soft magnetic powder may be used, or two or more types of soft magnetic powder may be used in combination.

In this embodiment, the closer the shape of particles of the magnetic powder 11 is to spherical, the better. When the sphericity of the particles is low, protrusions are formed on the surface of the particles. When a molding pressure is applied, stress from surrounding particles concentrates on the protrusions, causing the coating to break and a sufficiently high insulation cannot be maintained, which may result in deterioration of the magnetic properties (in particular, loss) of the resulting powder magnetic core. The sphericity of the particles may be controlled within a suitable range by adjusting manufacturing conditions of the magnetic powder such as a water volume and a water pressure of high-pressure water jet used for atomization if a water atomizing method is employed, the temperature and the supply rate of a molten material. The specific manufacturing conditions vary depending on the composition of the magnetic powder to be manufactured or the desired productivity. For example, the particle size of the magnetic powder 11 may be larger than or equal to 5 μm but smaller than or equal to 30 μm (median diameter D50).

The phosphoric acid-based insulating material 13 is an insulating material containing phosphate, for example, a phosphate-based glass may be used. In other words, the phosphoric acid-based insulating material 13 used in this embodiment is a low melting glass containing phosphate. Since the phosphoric acid-based insulating material 13 has a soft property, a highly functional insulating film can be formed on a surface of the magnetic powder 11 by coating the surface of the magnetic powder 11 with the phosphoric acid-based insulating material 13 using, for example, an insulation treatment performed by a mechanochemical method. The thickness of the phosphoric acid-based insulating material 13 with which the magnetic powder 11 is coated is preferably larger than or equal to 10 nm but smaller than or equal to 100 nm, and more preferably larger than or equal to 10 nm but smaller than or equal to 60 nm.

The moisture absorption inhibitor 14 is a moisture absorption inhibitor containing calcium, and, for example, calcium carbonate may be used. The moisture absorption inhibitor 14 has a function of preventing the powder magnetic core 1 from absorbing moisture. Note that, in this embodiment, any material that can prevent the powder magnetic core 1 from absorbing moisture may be used as the moisture absorption inhibitor 14.

The resin material 15 is, for example, a thermosetting resin. For example, at least one type of resin material selected from a group consisting of a silicon resin, a phenol resin, a polyimide resin, an epoxy resin, and an acrylic resin may be used as the resin material 15.

In this embodiment, a weight ratio (Ca/P) of calcium contained in the moisture absorption inhibitor 14 to phosphorus contained in the phosphoric acid-based insulating material 13 may be 0.10 or greater, preferably 0.29 or greater, more preferably 0.44 or greater, and even more preferably 0.69 or greater. By setting the weight ratio (Ca/P) of calcium contained in the moisture absorption inhibitor 14 to phosphorus contained in the phosphoric acid-based insulating material 13 so that it falls within the above range, it is possible to effectively prevent the powder magnetic core 1 from absorbing moisture and improve the reliability of the inductor.

Further, in this embodiment, a volume ratio of the moisture absorption inhibitor 14 to the phosphoric acid-based insulating material 13 is 7% or greater, preferably 20% or greater, more preferably 30%, and even more preferably 50% or greater. By setting the volume ratio of the moisture absorption inhibitor 14 to the phosphoric acid-based insulating material 13 so that it falls within the above range, it is possible to effectively prevent the powder magnetic core 1 from absorbing moisture and improve the reliability of the inductor.

In the powder magnetic core 1 according to this embodiment, the surface of the magnetic powder 11 is coated using the phosphoric acid-based insulating material 13. Note that, since the phosphoric acid-based insulating material 13 has a soft property, a highly functional insulating film can be formed on a surface of the magnetic powder 11 by coating the surface of the magnetic powder 11 using the phosphoric acid-based insulating material 13. However, since the phosphoric acid-based insulating material 13 has a high moisture absorption property, the powder magnetic core absorbs moisture in the air when the powder magnetic core is placed in an environment of high temperature and high humidity. This causes a problem that the durability of the powder magnetic core deteriorates, and hence the reliability of the inductor deteriorates. That is, when the powder magnetic core absorbs moisture from the air and is subsequently heated, the absorbed moisture expands, which can lead to cracking of the core and degradation of its properties. This causes a problem that the properties of the powder magnetic core deteriorates, and hence the reliability of the inductor deteriorates.

Therefore, in this embodiment, the moisture absorption inhibitor 14 is included in the insulating layer 12 of the powder magnetic core 1. As described above, by including the moisture absorption inhibitor 14 in the insulating layer 12, it is possible to prevent the powder magnetic core 1 (the phosphoric acid-based insulating material 13) from absorbing moisture and improve the reliability of the inductor.

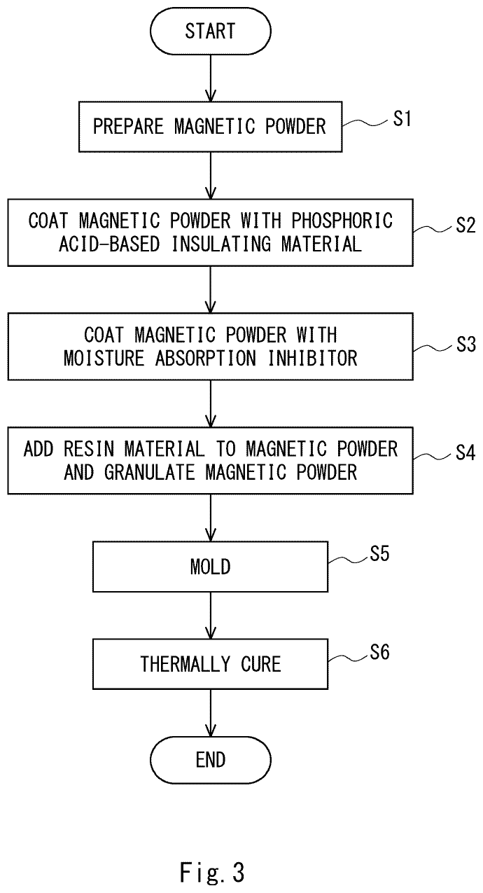

Next, a method for manufacturing a powder magnetic core according to this embodiment will be described. First, a method for manufacturing the powder magnetic core 1_1 (see FIG. 1) according to the first aspect will be described with reference to the flowchart shown in FIG. 3.

As shown in FIG. 3, when the powder magnetic core 1_1 according to the first aspect is manufactured, the magnetic powder 11 is first prepared (Step S1). The above-described magnetic powder may be used as the magnetic powder 11. Next, the magnetic powder 11 is coated with the phosphoric acid-based insulating material 13 (Step S2). For example, a phosphate-based glass may be used as the phosphoric acid-based insulating material 13. A method for coating the magnetic powder 11 with the phosphoric acid-based insulating material 13 can be suitably selected, for example, from among a powder mixing method, a mechanochemical method, a dipping method, a sol-gel method, a CVD method, a PVD method, or other known methods. The average thickness of the phosphoric acid-based insulating material 13 is preferably 10 to 100 nm, and more preferably 10 to 60 nm in order to secure insulation resistance and prevent a resin cured material from being oxidized.

Next, the magnetic powder 11 coated with the phosphoric acid-based insulating material 13 is coated with the moisture absorption inhibitor 14 (Step S3). For example, calcium carbonate may be used as the moisture absorption inhibitor 14. When the magnetic powder 11 is coated with the moisture absorption inhibitor 14, a method therefor can be suitably selected from among a powder mixing method, a mechanochemical method, a dipping method, a sol-gel method, a CVD method, a PVD method, or other known methods. For example, the moisture absorption inhibitor 14 can be dispersed in a binder and adhered to the surface of the magnetic powder 11 while being dried.

Next, the resin material 15 is added to the magnetic powder 11 coated with the moisture absorption inhibitor 14, and the magnetic powder 11 to which the resin material 15 has been added is granulated (Step S4). The above-described resin material may be used as the resin material 15. A material that is softened at about 100° C. and functions as an insulating material and a binding material after it is thermally cured is preferably used as the resin material 15. When the magnetic powder 11 is coated with the resin material (when the magnetic powder 11 is granulated), a rolling granulation method, a spray drying method, or the like may be used. Specifically, by mixing the resin material dissolved in an organic solvent with the magnetic powder 11 coated with the moisture absorption inhibitor 14 and drying the obtained mixture, a resin layer including the resin material 15 can be formed on the surface of the magnetic powder 11 coated with the moisture absorption inhibitor 14.

Note that, in this embodiment, a magnetic powder that is not coated with the resin material 15 may be partially present. Further, in this embodiment, it is preferable to use a thermosetting resin as the resin material 15.

Next, the granulated magnetic powder is molded (Step S5). For example, the molding can be performed by putting the granulated magnetic powder into a mold and pressurizing it.

Next, a molded body obtained by molding the granulated magnetic powder is thermally cured (Step S6). For example, the molded body is heated at 150° C. to 250° C. for two hours to thermally cure the resin material (the binder). Note that, in this embodiment, a granulated magnetic powder may be preformed, and the intermediate molded body that has been subjected to the preforming may be subjected to hot forming. The hot forming can be performed by heating the intermediate molded body that has been subjected to the preforming while pressurizing it in a state in which the intermediate molded body is in a mold.

By using the manufacturing method described above, the powder magnetic core 1_1 according to the first aspect (see FIG. 1) can be manufactured. When the powder magnetic core 1_1 according to the first aspect is manufactured, the weight ratio (Ca/P) of calcium contained in the moisture absorption inhibitor 14 to phosphorus contained in the phosphoric acid-based insulating material 13 may be set to 0.10% or greater, preferably 0.29 or greater, more preferably 0.44 or greater, and even more preferably 0.69 or greater.

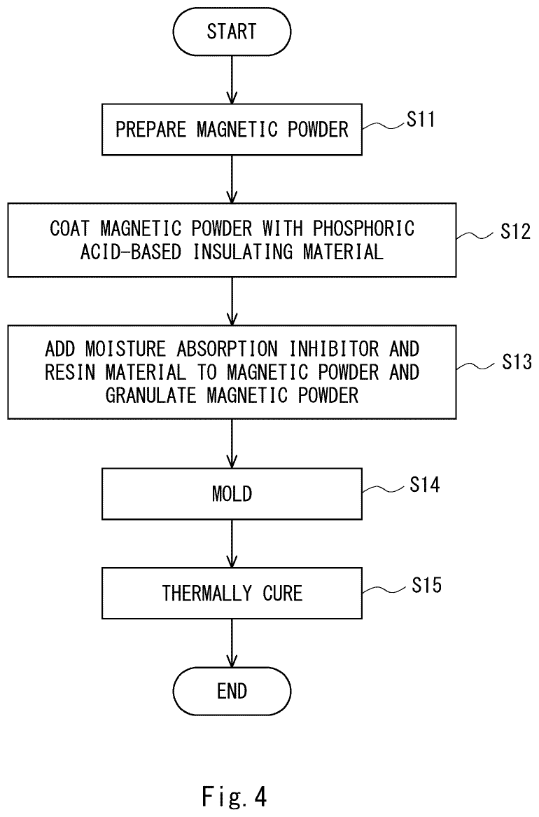

Next, a method for manufacturing the powder magnetic core 1_2 according to the second aspect (see FIG. 2) will be described with reference to the flowchart shown in FIG. 4.

As shown in FIG. 4, when the powder magnetic core 1_2 according to the second aspect is manufactured, the magnetic powder 11 is first prepared (Step S11). The above-described magnetic powder may be used as the magnetic powder 11. Next, the magnetic powder 11 is coated with the phosphoric acid-based insulating material 13 (Step S12). For example, a phosphate-based glass may be used as the phosphoric acid-based insulating material 13. A method for coating the magnetic powder 11 with the phosphoric acid-based insulating material 13 can be suitably selected, for example, from among a powder mixing method, a mechanochemical method, a dipping method, a sol-gel method, a CVD method, a PVD method, or other known methods. The average thickness of the phosphoric acid-based insulating material 13 is preferably 10 to 100 nm, and more preferably 10 to 60 nm in order to secure insulation resistance and prevent a resin cured material from being oxidized.

Next, the moisture absorption inhibitor 14 and the resin material 15 are added to the magnetic powder 11 coated with the phosphoric acid-based insulating material 13, and the magnetic powder 11 to which the moisture absorption inhibitor 14 and the resin material 15 have been added is granulated (Step S13). For example, calcium carbonate may be used as the moisture absorption inhibitor 14. The above-described resin material may be used as the resin material 15. A material that is softened at about 100° C. and functions as an insulating material and a binding material after it is thermally cured is preferably used as the resin material 15. When the magnetic powder 11 is coated with the moisture absorption inhibitor 14 and the resin material 15 (when the magnetic powder 11 is granulated), a rolling granulation method, a spray drying method, or the like may be used. Specifically, by mixing an organic solvent, the moisture absorption inhibitor 14, and the resin material 15 with the magnetic powder 11 coated with the phosphoric acid-based insulating material 13 and drying the obtained mixture, a resin layer including the moisture absorption inhibitor 14 and the resin material 15 can be formed on the surface of the magnetic powder 11 coated with the phosphoric acid-based insulating material 13.

Note that, in this embodiment, the magnetic powder that is not coated with the moisture absorption inhibitor 14 and the resin material 15 may be partially present. Further, in this embodiment, it is preferable to use a thermosetting resin as the resin material 15.

Next, the granulated magnetic powder is molded (Step S14). For example, the molding can be performed by putting the granulated magnetic powder into a mold and pressurizing it.

Next, a molded body obtained by molding the granulated magnetic powder is thermally cured (Step S15). For example, the molded body is heated at 150° C. to 250° C. for two hours to thermally cure the resin material (the binder). Note that, in this embodiment, a granulated magnetic powder may be preformed, and the intermediate molded body that has been subjected to the preforming may be subjected to hot forming. The hot forming can be performed by heating the intermediate molded body that has been subjected to the preforming while pressurizing it in a state in which the intermediate molded body is in a mold.

By using the manufacturing method described above, the powder magnetic core 1_2 according to the second aspect (see FIG. 2) can be manufactured. When the powder magnetic core 1_2 according to the second aspect is manufactured, the weight ratio (Ca/P) of calcium contained in the moisture absorption inhibitor 14 to phosphorus contained in the phosphoric acid-based insulating material 13 may be set to 0.10% or greater, preferably 0.29 or greater, more preferably 0.44 or greater, and even more preferably 0.69 or greater.

Note that the weight ratio (Ca/P) of calcium contained in the moisture absorption inhibitor 14 to phosphorus contained in the phosphoric acid-based insulating material 13 can be obtained, for example, by analyzing the composition of the powder magnetic core 1. For example, the composition of the entire powder magnetic core 1 may be analyzed using Energy dispersive X-ray spectroscopy (EDS). When doing so, if phosphorus is contained in the magnetic powder 11, the amount of phosphorus contained in the magnetic powder 11 is obtained in advance, and the amount of phosphorus contained in the magnetic powder 11 is subtracted from the amount of phosphorus contained in the entire powder magnetic core 1, whereby the amount of phosphorus contained in the phosphoric acid-based insulating material 13 can be obtained. Further, the amount of phosphorus contained in the phosphoric acid-based insulating material 13, which is a raw material, may be obtained in advance, and the weight ratio (Ca/P) of the calcium to the phosphorus may be obtained using calculation.

Further, the powder magnetic core 1 may be observed using a Scanning Electron Microscope (SEM) and then calcium contained in the moisture absorption inhibitor 14 and phosphorus contained in the phosphoric acid-based insulating material 13 may be analyzed using the EDS, whereby the weight ratio (Ca/P) of the calcium to the phosphorus may be obtained.

### EXAMPLES

Next, Examples will be described.

### <Experiment 1>

### (Preparation of Samples)

The following Experiment was conducted in order to confirm the effect of a moisture absorption inhibitor (calcium carbonate).

A powder magnetic core according to a sample 1-1 was prepared using the method for manufacturing the powder magnetic core 1_2 according to the second aspect shown in FIG. 4. Specifically, first, a magnetic powder was prepared. An Fe—Si—Cr alloy powder having a particle size of 10 μm (median diameter D50) was used as the magnetic powder. Next, the magnetic powder and a phosphoric acid-based insulating material A were mixed, and the magnetic powder was coated with the phosphoric acid-based insulating material A using a mechanochemical method. The phosphoric acid-based insulating material A having the composition shown in a sample 2-1 in Table 2 was used.

Then, a moisture absorption inhibitor (calcium carbonate) and a resin material were added to the magnetic powder coated with the phosphoric acid-based insulating material A, and the magnetic powder to which the moisture absorption inhibitor and the resin material were added was granulated. A silicon resin was used as the resin material. At this time, the volume ratios of the phosphoric acid-based insulating material A, the calcium carbonate, and the resin material were set to 2.0 vol %, 2.0 vol %, and 32.0 vol %, respectively (see Table 1). Note that the volume ratios of the phosphoric acid-based insulating material A, the calcium carbonate, and the resin material indicate the volume ratio of the phosphoric acid-based insulating material A to the magnetic powder, the volume ratio of the calcium carbonate to the magnetic powder, and the volume ratio of the resin material to the magnetic powder.

Next, the granulated magnetic powder was put into a mold, pressurized, and then molded. Then, a molded body obtained by molding the granulated magnetic powder was heated at 200° C. for two hours and thermally cured.

The powder magnetic core according to the sample 1-1 was prepared using the method described above. Further, a sample 1-2 to which mica was added instead of calcium carbonate was prepared. Further, a sample 1-3 to which talc was added instead of calcium carbonate was prepared. Further, a sample 1-4 to which an additive such as calcium carbonate was not added was prepared. Note that a method for manufacturing each of the samples 1-2 to 1-4 is similar to that for manufacturing the sample 1-1 except that different additives were added thereto.

### (Environmental Test)

The environmental test described below was conducted on each of the prepared samples.

First, the weight of each of the samples before the environmental test was measured. Then, the samples were left in the environment of a temperature of 85° C. and a humidity of 85% for one week, to thereby conduct the environmental test. Then, the weight of each of the samples after the environmental test was measured. Table 1 shows the weight increase rate of each of the samples 1-1 to 1-4 after the environmental test.

As shown in Table 1, in the sample 1-1 to which calcium carbonate was added, the weight increase rate after the environmental test was 0%. Meanwhile, in the sample 1-2 to which mica was added instead of calcium carbonate, the weight increase rate after the environmental test was 0.14%. Further, in the sample 1-3 to which talc was added instead of calcium carbonate, the weight increase rate after the environmental test was 0.13%. Further, in the sample 1-4 to which an additive was not added, the weight increase rate after the environmental test was 0.32%. Thus, in each of the samples 1-2 to 1-4, the weight thereof increased since the powder magnetic core absorbed moisture by the environmental test. On the other hand, in the sample 1-1 to which calcium carbonate was added, the weight increase rate after the environmental test was 0%, and the powder magnetic core was thus prevented from absorbing moisture. As a result, it was found that the addition of calcium carbonate as an additive prevented the powder magnetic core from absorbing moisture.

TABLE 1

| | Phosphoric | | | | Weight |
|---|---|---|---|---|---|
| | acid- | | | | increase |
| | based | | | | rate |
| | insulating | | | Resin | after |
| | material | Additive | | material | environmental |
| | A (vol %) | (vol %) | | (vol %) | test (%) |
| Sample 1-1 | 2.0 | Calcium | 2.0 | 32.0 | 0.00 |
| | | carbonate | | | |
| Sample 1-2 | 2.0 | Mica | 2.0 | 32.0 | 0.14 |
| Sample 1-3 | 2.0 | Talc | 2.0 | 32.0 | 0.13 |
| Sample 1-4 | 4.0 | None | — | 32.0 | 0.32 |

### <Experiment 2>

Next, the following Experiment was conducted in order to confirm the effect of a moisture absorption inhibitor (calcium carbonate) when different phosphoric acid-based insulating materials are used.

### (Preparation of Samples)

First, 1.0 g of a phosphoric acid-based insulating material A and a phosphoric acid-based insulating material B were prepared. The compositions of the phosphoric acid-based insulating material A and the phosphoric acid-based insulating material B were analyzed using the EDS. The analyzed compositions thereof were shown in Table 2. Then, the phosphoric acid-based insulating material A was used as the sample 2-1. At this time, two types of samples, which are a sample to which calcium carbonate was added and a sample to which no calcium carbonate was added, were prepared. In the sample to which calcium carbonate was added, the volume ratio of the phosphoric acid-based insulating material A to the calcium carbonate was set to 1:1. The above samples are denoted as the sample 2-1 (with calcium carbonate) and the sample 2-1 (without calcium carbonate).

Further, the phosphoric acid-based insulating material B was used as a sample 2-2. At this time, two types of samples, which are a sample to which calcium carbonate was added and a sample to which no calcium carbonate was added, were prepared. In the sample to which calcium carbonate was added, the volume ratio of the phosphoric acid-based insulating material B to the calcium carbonate was set to 1:1. The above samples are denoted as the sample 2-2 (with calcium carbonate) and the sample 2-2 (without calcium carbonate).

Then, each of the prepared samples was placed in a petri dish and dried at 125° C. Then, the petri dishes in which the respective samples were placed were weighed (each of the weights thereof at this time is referred to as a weight A). Then, the petri dishes in which the respective samples were placed and a petri dish including water prepared separately were accommodated in the same container, and then this container was sealed. After 300 hours elapsed, the petri dish dishes in which the respective samples were placed were weighed (each of the weights thereof at this time is referred to as a weight B), and the weight increase rate of each of the samples was calculated using the following equation.

Weight increase rate (%)={(the weight B−the weight A)/the weight A}×100

The weight increase rates obtained in this way are shown in Table 2. As shown in Table 2, the weight increase rate of the sample 2-1 (without calcium carbonate) was high, while the weight increase rate of the sample 2-1 (with calcium carbonate) was low. Thus, in the sample 2-1 (with calcium carbonate) to which calcium carbonate was added, the absorption of moisture was prevented. Further, the weight increase rate of the sample 2-2 (without calcium carbonate) was high, while the weight increase rate of the sample 2-2 (with calcium carbonate) was low. Thus, in the sample 2-2 (with calcium carbonate) to which calcium carbonate was added, the absorption of moisture was prevented.

From the results of Experiment 2, the effect of addition of calcium carbonate on the prevention of moisture absorption was confirmed in both the phosphoric acid-based insulating material A and the phosphoric acid-based insulating material B.

TABLE 2

| | | Sample 2-1 | Sample 2-2 |
|---|---|---|---|
| | | Phosphate-based | Phosphate-based |
| | | glass A (mass %) | glass B (mass %) |
| Composition | F | — | — |
| of phosphate- | Na | 10.2 | — |
| based | Al | 4.4 | 18.8 |
| glass | Si | 0.0 | 6.09 |
| | P | 58.8 | 53.4 |
| | K | — | — |
| | Ca | — | — |
| | Ti | 2.8 | — |
| | Zn | 23.7 | 21.76 |

| | | |
|---|---|---|
| Weight increase rate (%) | 40 | 26 |
| (without calcium carbonate) | | |
| Weight increase rate (%) | 4.3 | 19.0 |
| (with calcium carbonate) | | |
| Effect of calcium carbonate | Confirmed | Confirmed |

### <Experiment 3>

### (Preparation of Samples)

Powder magnetic cores according to samples 3-1 to 3-4 were prepared using the method for manufacturing the powder magnetic core 1_1 according to the first aspect shown in FIG. 3. Specifically, first, a magnetic powder was prepared. An Fe—Si—Cr alloy powder having a particle size of 10 μm (median diameter D50) was used as the magnetic powder. Next, the magnetic powder and a phosphoric acid-based insulating material A were mixed, and the magnetic powder was coated with the phosphoric acid-based insulating material A using a mechanochemical method.

Next, the magnetic powder coated with the phosphoric acid-based insulating material A was coated with a moisture absorption inhibitor (calcium carbonate). Then, a resin material was added to the magnetic powder coated with the phosphoric acid-based insulating material A and the calcium carbonate, and the magnetic powder to which the resin material was added was granulated. A silicon resin was used as the resin material. The amounts of the phosphoric acid-based insulating material A, the calcium carbonate, the magnetic powder, and the resin material in the samples 3-1 to 3-4 were as shown in Table 3.

Note that the volume ratios of the phosphoric acid-based insulating material A and the calcium carbonate shown in Table 3 indicate the volume ratio of the phosphoric acid-based insulating material A to the magnetic powder and the volume ratio of the calcium carbonate to the magnetic powder. That is, the volume ratio (vol %) of the phosphoric acid-based insulating material A is the volume ratio of the phosphoric acid-based insulating material A to the magnetic powder. Further, the volume ratio (vol %) of the calcium carbonate is the volume ratio of the calcium carbonate to the magnetic powder. Further, the weight (g) of each of the magnetic powder, the phosphoric acid-based insulating material A, the calcium carbonate, and the resin material shown in Table 3 is the content of each of these materials contained in 2.5 g of the powder magnetic core.

Next, the granulated magnetic powder was put into a mold and pressurized under the condition of 5000 kgf/cm². Then, the molded body was heated at a temperature of 200° C. for two hours and thermally cured.

The powder magnetic cores according to the samples 3-1 to 3-4 were prepared using the method described above. The sample 3-1 is a sample to which the calcium carbonate was not added. The sample 3-2 is a sample in which the volume ratio of the calcium carbonate to the phosphoric acid-based insulating material A is 0.10 and the weight ratio (Ca/P) of calcium contained in the moisture absorption inhibitor to phosphorus contained in the phosphoric acid-based insulating material is 0.14. The sample 3-3 is a sample in which the volume ratio of the calcium carbonate to the phosphoric acid-based insulating material A is 0.50 and the weight ratio (Ca/P) of calcium contained in the moisture absorption inhibitor to phosphorus contained in the phosphoric acid-based insulating material is 0.69. The sample 3-4 is a sample in which the volume ratio of the calcium carbonate to the phosphoric acid-based insulating material A is 0.75 and the weight ratio (Ca/P) of calcium contained in the moisture absorption inhibitor to phosphorus contained in the phosphoric acid-based insulating material is 1.03.

### (Environmental Test)

The environmental test described below was conducted on each of the prepared samples.

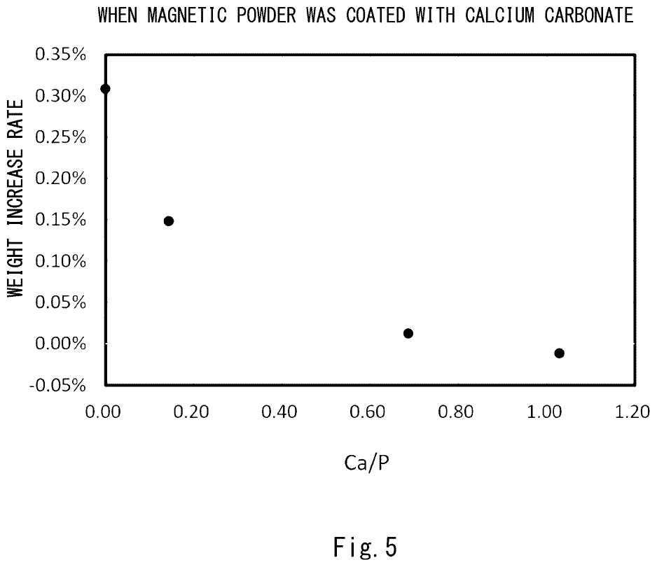

First, the weight of each of the samples before the environmental test was measured. Then, the samples were left in the environment of a temperature of 85° C. and a humidity of 85% for one week, to thereby conduct the environmental test. Then, the weight of each of the samples after the environmental test was measured. Table 3 shows the weight increase rate of each of the samples 3-1 to 3-4 after the environmental test. Further, the graph in FIG. 5 shows the relationship between Ca/P and the weight increase rates.

As shown in Table 3 and FIG. 5, in the sample 3-1 to which the calcium carbonate was not added, the weight increase rate after the environmental test was 0.31%. Further, in the samples 3-2 to 3-4 to each of which the calcium carbonate was added, the weight increase rates after the environmental test were 0.15%, 0.01%, and −0.01%, respectively. From the above results, it was found that the weight increase rate after the environmental test decreased as the amount of calcium carbonate increased.

TABLE 3

| | Phosphoric acid- | | | | Phosphoric acid- | | Resin | | Weight |
|---|---|---|---|---|---|---|---|---|---|
| | based insulating | CaCO₃ | Volume | Magnetic | based insulating | CaCO₃ | material | | increase |
| | material A (vol %) | (vol %) | ratio | powder (g) | material A (g) | (g) | (g) | Ca/P | rate (%) |
| Sample 3-1 | 4.0 | 0.00 | 0.00 | 2.25 | 0.034 | 0.000 | 0.219 | 0.00 | 0.31 |
| Sample 3-2 | 2.7 | 0.27 | 0.10 | 2.12 | 0.159 | 0.016 | 0.203 | 0.14 | 0.15 |
| Sample 3-3 | 2.7 | 1.34 | 0.50 | 2.07 | 0.155 | 0.075 | 0.198 | 0.69 | 0.01 |
| Sample 3-4 | 2.7 | 2.00 | 0.75 | 2.04 | 0.153 | 0.110 | 0.195 | 1.03 | −0.01 |

### <Experiment 4>

### (Preparation of Samples)

Powder magnetic cores according to samples 4-1 to 4-5 were prepared using the method for manufacturing the powder magnetic core 1_2 according to the second aspect shown in FIG. 4. Specifically, first, a magnetic powder was prepared. An Fe—Si—Cr alloy powder having a particle size of 10 μm (median diameter D50) was used as the magnetic powder. Next, the magnetic powder and a phosphoric acid-based insulating material A were mixed, and the magnetic powder was coated with the phosphoric acid-based insulating material A using a mechanochemical method.

Then, a moisture absorption inhibitor (calcium carbonate) and a resin material were added to the magnetic powder coated with the phosphoric acid-based insulating material A, and the magnetic powder to which the moisture absorption inhibitor and the resin material were added was granulated. A silicon resin was used as the resin material. The amounts of the phosphoric acid-based insulating material A, the calcium carbonate, the magnetic powder, and the resin material in the samples 4-1 to 4-5 were as shown in Table 4.

Note that the volume ratios of the phosphoric acid-based insulating material A and the calcium carbonate shown in Table 4 indicate the volume ratio of the phosphoric acid-based insulating material A to the magnetic powder and the volume ratio of the calcium carbonate to the magnetic powder. Further, the weight (g) of each of the magnetic powder, the phosphoric acid-based insulating material A, the calcium carbonate, and the resin material shown in Table 4 is the content of each of these materials contained in 2.5 g of the powder magnetic core.

Next, the granulated magnetic powder was put into a mold and pressurized under the condition of 5000 kgf/cm². Then, the molded body was heated at a temperature of 200° C. for two hours and thermally cured.

The powder magnetic cores according to the samples 4-1 to 4-5 were prepared using the method described above. The sample 4-1 is a sample to which the calcium carbonate was not added. The sample 4-2 is a sample in which the volume ratio of the calcium carbonate to the phosphoric acid-based insulating material A is 0.07 and the weight ratio (Ca/P) of calcium contained in the moisture absorption inhibitor to phosphorus contained in the phosphoric acid-based insulating material is 0.10. The sample 4-3 is a sample in which the volume ratio of the calcium carbonate to the phosphoric acid-based insulating material A is 0.20 and the weight ratio (Ca/P) of calcium contained in the moisture absorption inhibitor to phosphorus contained in the phosphoric acid-based insulating material is 0.29. The sample 4-4 is a sample in which the volume ratio of the calcium carbonate to the phosphoric acid-based insulating material A is 0.30 and the weight ratio (Ca/P) of calcium contained in the moisture absorption inhibitor to phosphorus contained in the phosphoric acid-based insulating material is 0.44. The sample 4-5 is a sample in which the volume ratio of the calcium carbonate to the phosphoric acid-based insulating material A is 0.68 and the weight ratio (Ca/P) of calcium contained in the moisture absorption inhibitor to phosphorus contained in the phosphoric acid-based insulating material is 0.97.

### (Environmental Test)

The environmental test described below was conducted on each of the prepared samples.

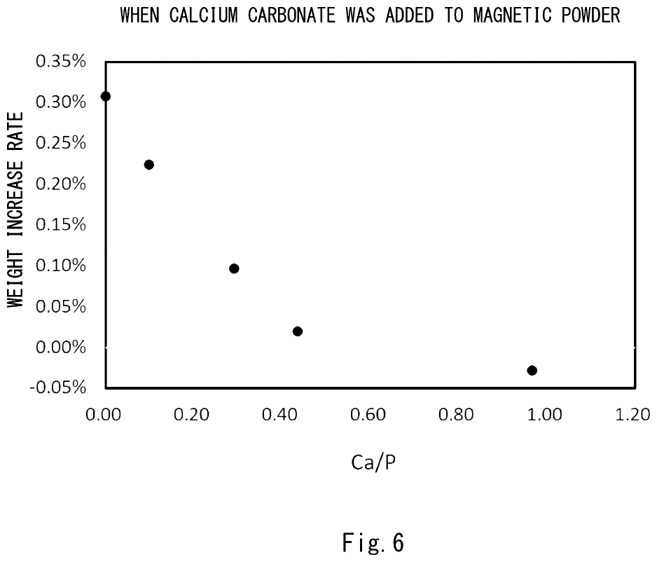

First, the weight of each of the samples before the environmental test was measured. Then, the samples were left in the environment of a temperature of 85° C. and a humidity of 85% for one week, to thereby conduct the environmental test. Then, the weight of each of the samples after the environmental test was measured. Table 4 shows the weight increase rate of each of the samples 4-1 to 4-5 after the environmental test. Further, the graph in FIG. 6 shows the relationship between Ca/P and the weight increase rates.

As shown in Table 4 and FIG. 6, in the sample 4-1 to which the calcium carbonate was not added, the weight increase rate after the environmental test was 0.31%. Further, in the samples 4-2 to 4-5 to each of which the calcium carbonate was added, the weight increase rates after the environmental test were 0.22%, 0.10%, 0.02%, and −0.03%, respectively. From the above results, it was found that the weight increase rate after the environmental test decreased as the amount of calcium carbonate increased.

TABLE 4

| | Phosphoric acid- | | | | Phosphoric acid- | | Resin | | Weight |
|---|---|---|---|---|---|---|---|---|---|
| | based insulating | CaCO₃ | Volume | Magnetic | based insulating | CaCO₃ | material | | increase |
| | material A (vol %) | (vol %) | ratio | powder (g) | material A (g) | (g) | (g) | Ca/P | rate (%) |
| Sample 4-1 | 4.0 | 0.00 | 0.00 | 2.25 | 0.034 | 0.000 | 0.219 | 0.00 | 0.31 |
| Sample 4-2 | 4.0 | 0.27 | 0.07 | 2.24 | 0.034 | 0.0023 | 0.227 | 0.10 | 0.22 |
| Sample 4-3 | 4.0 | 0.81 | 0.20 | 2.23 | 0.033 | 0.0068 | 0.227 | 0.29 | 0.10 |
| Sample 4-4 | 4.0 | 1.20 | 0.30 | 2.23 | 0.033 | 0.0102 | 0.227 | 0.44 | 0.02 |
| Sample 4-5 | 4.0 | 2.70 | 0.68 | 2.22 | 0.033 | 0.0225 | 0.226 | 0.97 | −0.03 |

Although the present invention has been described above with reference to the above embodiments, the present invention is not limited only to the configurations of the above-described embodiments. Needless to say, the present invention includes various modifications, changes, and combinations that can be made by a person skilled in the art within the scope of the claimed invention of the present application.

This application is based upon and claims the benefit of priority from Japanese patent application No. 2023-20052, filed on Feb. 13, 2023, the disclosure of which is incorporated herein in its entirety by reference.

### REFERENCE SIGNS LIST

1, 1_1, 1_2 POWDER MAGNETIC CORE
11 MAGNETIC POWDER
12, 12_1, 12_2 INSULATING LAYER
13 PHOSPHORIC ACID-BASED INSULATING MATERIAL
14 MOISTURE ABSORPTION INHIBITOR
15 RESIN MATERIAL

1. A powder magnetic core in which a magnetic powder is bonded via an insulating layer,
wherein the insulating layer includes a phosphoric acid-based insulating material, a resin material, and a moisture absorption inhibitor containing calcium.

2. The powder magnetic core according to claim 1, wherein a weight ratio (Ca/P) of calcium contained in the moisture absorption inhibitor to phosphorus contained in the phosphoric acid-based insulating material is 0.10 or greater.

3. The powder magnetic core according to claim 1, wherein a weight ratio (Ca/P) of calcium contained in the moisture absorption inhibitor to phosphorus contained in the phosphoric acid-based insulating material is 0.44 or greater.

4. The powder magnetic core according to claim 1, wherein the moisture absorption inhibitor containing calcium is calcium carbonate.

5. The powder magnetic core according to claim 1, wherein the phosphoric acid-based insulating material is a phosphate-based glass.

6. The powder magnetic core according to claim 1, wherein the resin material is a thermosetting resin.

7. The powder magnetic core according to claim 1, wherein a volume ratio of the moisture absorption inhibitor to the phosphoric acid-based insulating material is 7% or greater.

8. The powder magnetic core according to claim 1, wherein
a surface of the magnetic powder is coated with the phosphoric acid-based insulating material, and
a thickness of the phosphoric acid-based insulating material with which the magnetic powder is coated is larger than or equal to 10 nm but smaller than or equal to 100 nm.

9. An inductor comprising the powder magnetic core according to claim 1 and a coil.

10. A method for manufacturing a powder magnetic core, the method comprising:
a process of coating a surface of a magnetic powder with a phosphoric acid-based insulating material;
a process of coating the magnetic powder coated with the phosphoric acid-based insulating material with a moisture absorption inhibitor containing calcium;
a process of adding a resin material to the magnetic powder coated with the moisture absorption inhibitor and granulating the magnetic powder to which the resin material has been added; and
a process of molding and thermally curing the granulated magnetic powder.

11. A method for manufacturing a powder magnetic core, the method comprising:
a process of coating a surface of a magnetic powder with a phosphoric acid-based insulating material;
a process of adding a moisture absorption inhibitor containing calcium and a resin material to the magnetic powder coated with the phosphoric acid-based insulating material and granulating the magnetic powder to which the moisture absorption inhibitor and the resin material have been added; and
a process of molding and thermally curing the granulated magnetic powder.
